(19) United States
(12) Patent Application Publication
(10) Pub. No.: US 2025/0343265 A1
(43) Pub. Date: Nov. 6, 2025

(54) ELECTROLYTE ADDITIVES FOR LITHIUM SECONDARY BATTERY, ELECTROLYTE FOR LITHIUM SECONDARY BATTERY, AND LITHIUM SECONDARY BATTERTY COMPRISING SAME

(71) Applicants: Hyundai Motor Company, Seoul (KR); Kia Corporation, Seoul (KR)

(72) Inventors: Kyuju Kwak, Hwaseong (KR); Ji Yong Lee, Hwaseong (KR); Won Keun Kim, Hwaseong (KR); Eunji Kwon, Hwaseong (KR); Yeonjong Oh, Hwaseong (KR); Jiho Lim, Hwaseong (KR); Dong Hyun Lee, Hwaseong (KR); Sangsu Lee, Hwaseong (KR); Kyoung Han Ryu, Hwaseong (KR); Samuel Seo, Hwaseong (KR)

(21) Appl. No.: 19/197,817

(22) Filed: May 2, 2025

(30) Foreign Application Priority Data
May 3, 2024 (KR) 10-2024-0059142

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0034

(57) ABSTRACT

An electrolyte additive for a lithium rechargeable battery, having a permittivity of 1.0 F/m or less and represented by the following formula 1 is provided:

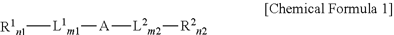

A is carbon or silicon, and R1 and R2 can be various substituted or unsubstituted alkyl, heteroalkyl, cyclic, or aryl groups. The compound can exhibit a LUMO of −0.6 eV or higher and a HOMO of −6.8 eV or higher. Also provided is an electrolyte containing the additive, a LIFSI salt, and a main solvent comprising either an ether or a fluorine-substituted sulfamoyl, in a ratio of about 0.99:0.01 to about 0.95:0.05. A lithium rechargeable battery incorporating this electrolyte together with positive and negative electrodes and a separator, demonstrates enhanced performance and stability.

### CROSS-REFERENCE TO RELATED APPLICATION

This application claims under 35 U.S.C. § 119(a) the benefit of Korean Patent Application No. 10-2024-0059142 filed in the Korean Intellectual Property Office on May 3, 2024, the entire contents of which are incorporated herein by reference.

### 1. FIELD

The present disclosure relates to an electrolyte additive for a lithium rechargeable battery, an electrolyte for a lithium rechargeable battery, and a lithium rechargeable battery including the same.

### 2. BACKGROUND

Ongoing research seeks to improve the performance of lithium rechargeable batteries by optimizing salt type, salt concentration, solvent systems, cosolvents, and additives. Among them, the introduction of new cosolvents or additives is attracting attention as a technology that can improve durability characteristics by delaying the decomposition of salts and solvents in electrolytes.

The cosolvent can be included in the electrolyte to implement local overconcentration to delay the decomposition of the solvent, increase the solubility of the salt to include an excess of salt, or play a role in improving physical characteristics such as wettability and viscosity.

In general, low donor number (DN) perfluorinated solvents that do not dissociate salts are used, and representative examples include TTE (1,1,2,2-tetrafluoroethyl-2,2,3,3-tetrafluoropropyl ether), BTFE (bis(2,2,2-trifluoroethyl ether)), and TFOFE (1,1,2,2-tetrafluoroethyl-1H,1H,5H-octafluoropentyl ether).

In lithium metal batteries, continuous salt degradation is becoming a key causative agent for durability degradation of N,N-dimethylsulfamoyl fluoride hereinafter referred to as DMSF)-based electrolytes. Oxidative environments at high voltage further accelerate this process.

Various additives are being developed to delay degradation, but the instability of the protective layer causes continuous consumption of the additive and increases electrode resistance, which can hinder the output characteristics. The aim was to induce salt-solvent aggregation and suppress decomposition of salt and solvent by applying a perfluorinated cosolvent that does not dissolve salt. However, the perfluorinated solvent continuously consumes lithium metal to form a film by reacting with it. At high temperatures, it is difficult to maintain the agglomeration phenomenon, making it difficult to adopt it as a strategy for commercial use in exothermic battery reactions.

Therefore, there is a need for an electrolyte that includes a co-solvent that suppresses the decomposition of salt while simultaneously preventing decomposition in the electrode reaction, thereby maintaining the effect.

In the present disclosure, the present disclosure was completed by developing an electrolyte additive that can delay the decomposition of FSI negative ion when added, thereby improving the durability of a lithium metal battery, and which does not decompose earlier than the main solvent, and providing an electrolyte containing the same.

### SUMMARY

In some embodiments, the present disclosure aims to provide an electrolyte additive and an electrolyte containing the same, which suppresses the decomposition of salt and allows the effect to last without being decomposed in an electrode reaction.

An electrolyte additive for a lithium rechargeable battery according to an embodiment is represented by the following Chemical Formula 1 (sometimes referred to as formula 1 or Formula 1) and may be an electrolyte additive for a lithium rechargeable battery preferably having a permittivity of 1.0 F/m or less:

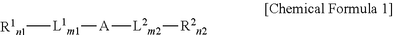

In Chemical Formula 1 above,
A is C or Si,
R¹ is a C1 to C10 alkyl group substituted with one or more halogens,
R² is hydrogen, deuterium, halogen, substituted or unsubstituted C1 to C10 alkyl group, substituted or unsubstituted C1 to C10 heteroalkyl group, substituted or unsubstituted C3 to C10 cycloalkyl group, substituted or unsubstituted C2 to C10 heterocycloalkyl group, substituted or unsubstituted C2 to C10 alkenyl group, substituted or unsubstituted C3 to C10 cycloalkenyl group, substituted or unsubstituted C1 to C10 heteroalkenyl group, substituted or unsubstituted C2 to C10 heterocycloalkenyl group, substituted or unsubstituted C2 to C10 alkynyl group, substituted or unsubstituted C3 to C10 cycloalkynyl group, substituted or unsubstituted C1 to C10 heteroalkynyl group, substituted or unsubstituted C2 to C10 heterocycloalkynyl group, substituted or unsubstituted C6 to C10 aryl group, substituted or unsubstituted C2 to C10 heteroaryl group, substituted or unsubstituted C1 to C10 alkoxy group, substituted or unsubstituted C2 to C10 aryloxy group, or any combination thereof,
L¹ and L² are independently, directly bonded, substituted or unsubstituted C1 to C10 alkyl groups,
n1 and n2 are independently integers between 1 and 3,
m1 and m2 can be independently any integer between 1 and 100.

According to some embodiments, the electrolyte may be an electrolyte for a lithium rechargeable battery, comprising an additive according to the present specification; and a linear or cyclic ether solvent or sulfamoyl solvent as a main solvent.

According to some embodiments, a lithium rechargeable battery may include a positive electrode; a negative electrode; and a separator interposed between the positive electrode and the negative electrode; and may include the electrolyte described above.

According to the present embodiment, the electrolyte additive for a lithium rechargeable battery can implement local overconcentration to delay solvent decomposition, increase salt solubility to include excess salt, or improve physical characteristics by including a specific structure such as a C1 to C10 alkyl group substituted with one or more halogens and having permittivity within a specific range.

According to some embodiments, a lithium rechargeable battery is provided and comprises: a positive electrode; a negative electrode; a separator interposed between the positive electrode and the negative electrode; and an electrolyte that contains:
(a) an electrolyte additive represented by

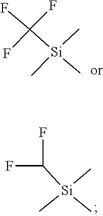

(b) LIFSI as a lithium salt; and
(c) a solvent component comprising a fluorine-substituted sulfonyl solvent,
wherein a mole ratio of the solvent component to the electrolyte additive is about 0.99:0.01 to 0.95:0.05.

The electrolyte additive may be represented by

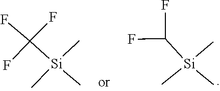

The fluorine-substituted sulfonyl solvent suitably may contain a fluorosulfonyl group represented by

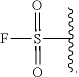 [SMILES: *S(=O)(=O)F]

The fluorine-substituted sulfonyl solvent suitably may be a solvent represented by

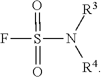

The fluorine-substituted sulfonyl solvent suitably is a primary or main solvent of a solvent component of an electrolyte as disclosed herein. For example, an electrolyte may comprise a solvent that is composed of at least 40, 50, 60, 70, 80, 90, 95 or 100 percent by weight of one or more fluorine-substituted sulfonyl solvents as disclosed herein, based on total weight of total solvent(s) present in the electrolyte. In addition, a lithium rechargeable battery manufactured as in the present embodiment forms an excellent solvent decomposition-type film between the lithium metal and the solvent, delays the decomposition of the FSI negative ion, increases the durability of the battery, and the included additive is not decomposed, so it can have a continuous effect, thereby exhibiting excellent performance.

As discussed, the method and system suitably include use of a controller or processer.

In another embodiment, vehicles are provided that comprise an apparatus as disclosed herein. In particular, vehicles are provided that a lithium rechargeable battery as disclosed herein.

### BRIEF DESCRIPTION OF THE DRAWINGS

FIG. 1 is a schematic diagram showing the effect of mixing a co-solvent with a solvent according to some embodiments of the present disclosure.

FIG. 2 is a schematic diagram showing the effect of mixing a co-solvent with a solvent according to a comparative example.

FIG. 3 is a configuration diagram of a coin cell including electrolytes according to an embodiment and a comparative example.

FIG. 4 is the measurement result of the average voltage and capacity change according to the charge/discharge performance of a coin cell containing electrolyte according to a comparative example.

FIG. 5 is a Nyquist plot of the impedance measurement result of a coin cell containing electrolyte according to a comparative example.

FIG. 6 is a graph illustrating capacity retention versus cycle number for coin cells charged at 1/3C (CC-CV) and discharged at 1/3C (CC), comparing electrolytes of Embodiments 1 and 2 with Comparative Examples 1 and 4 (1.5 g Ah⁻¹ additive).

FIG. 7 is a graph illustrating capacity retention versus cycle number for coin cells charged at 1/3C (CC-CV) and discharged at 1/3C (CC), comparing the electrolyte of Embodiment 3 with Comparative Examples 1 and 5 (1.5 g Ah⁻¹ additive).

FIG. 8 is a graph showing capacity retention versus cycle number for coin cells charged at 1C (CC-CV) and discharged at 1C (CC), comparing the electrolyte of Comparative Examples 1 and 2 (3.0 g Ah⁻¹ additive).

FIG. 9 is a graph showing capacity retention versus cycle number for coin cells charged at 1/3C (CC-CV) and discharged at 1/3C (CC), comparing electrolytes of Comparative Examples 1 and 3 (1.5 g Ah⁻¹ additive).

FIG. 10 is a drawing showing the residual amounts of solvent DMSF and lithium salt LiFSI according to charge/discharge performance in a coin cell containing Comparative Example 1 as an electrolyte.

FIG. 11A is a drawing showing the residual amount of solvent DMSF and lithium salt LiFSI and the residual amount of FSI/DMSF according to the charge/discharge performance in a coin cell containing Comparative Example 1 as an electrolyte.

FIG. 11B is a drawing showing the residual amount of solvent DMSF and lithium salt LiFSI and the residual amount of FSI/DMSF according to the charge/discharge performance in a coin cell containing embodiment 1 as an electrolyte.

FIG. 12 is a drawing showing the ¹⁷F-NMR result after 100 cycle, 1/3C operations in Li/NMC containing embodiment 1 as electrolyte.

FIG. 13 is a linear voltage-current (LSV) plot of the reduction reaction in coin cells using Comparative Example 1 electrolytes at salt-to-solvent mole ratios of 1:3, 1:4, and 1:5, illustrating the current measured near 2.5 V vs Li⁺.

FIG. 14 is a linear voltage-current (LSV) plot of the oxidation reaction in coin cells using the same Comparative Example 1 electrolytes at salt-to-solvent mole ratios of 1:3, 1:4, and 1:5, showing the current measured near 4.8 V vs Li⁺.

FIG. 15 is a linear voltage-current (LSV) plot comparing Embodiment 1 with Comparative Example 1, demonstrating a slight positive shift in the oxidation potential of the FSI salt when the additive of Embodiment 1 is employed.

FIG. 16 is a linear voltage-current (LSV) plot comparing Embodiment 1 with Comparative Example 1, demonstrating a significant negative shift (about 0.8V) in the reduction potential of the FSI salt and confirming delayed reduction-decomposition when the additive of Embodiment 1 is employed.

FIG. 17 is a drawing showing the energy levels derived from the DFT calculation results.

### DETAILED DESCRIPTION

The terminology used herein is for the purpose of referring only to particular embodiments and is not intended to limit the present disclosure. The singular forms used here also include the plural forms unless the phrases clearly indicate a contrary meaning. The term “comprising/including/containing/having” as used in the specification means specifying a particular characteristic, region, integer, step, operation, element and/or component, and does not preclude the presence or addition of any other characteristic, region, integer, step, operation, element and/or component.

The term “permittivity” herein refers to the measure of a material's ability to permit electric field lines to pass through it, typically expressed in farads per meter (F/m). The term permittivity as used herein may mean relative permittivity.

Permittivity as referred to herein can be determined by known methods including an impedance analyzer (e.g. as available form Hewlett Packard such as the Hewlett Packard 4194A). For example, in this method, a sample is introduced into an electrode cell, a voltage and a frequency are applied, the capacitance stored between the electrodes is measured, and the relative permittivity (∈ᵣ) of the sample is measured according to the formula ∈ᵣ=Cₚ/Cₒ wherein Cₚ: capacitance of sample; Cₒ: capacitance of air.

As an alternative distinct method for determining permittivity, a protocol as used in JIS C 2565 (resonant cavity method) may be employed for example using closed sample insertion hole-type (closed sample insertion hole-type resonant cavity perturbation method). For instance, in this analysis method, a sample is inserted into a cavity resonator and the variation in the resonance frequency before and after sample insertion is measured, allowing the permittivity to be calculated.

The term “HOMO energy level” herein refers to the energy of the highest occupied molecular orbital of a molecule, typically measured in electronvolts (eV).

The term “LUMO energy level” herein refers to the energy of the lowest unoccupied molecular orbital of a molecule, typically measured in electronvolts (eV).

The term “main solvent” herein refers to the primary liquid medium in which the lithium salt and other electrolyte components are dissolved, consisting at least about 50 wt % of the total solvent system.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Although not otherwise defined, all terms, including technical and scientific terms, used herein have the same meaning as is generally understood by a person of ordinary skill in the art to which the present disclosure belongs. Terms defined in commonly used dictionaries are additionally interpreted to have a meaning consistent with the relevant technical literature and the present disclosure and are not to be interpreted in an ideal or very formal sense unless otherwise defined.

The terms first, second, and third are used to describe, but are not limited to, various parts, components, regions, layers, and/or sections. These terms are used only to distinguish one part, component, region, layer or section from another part, component, region, layer or section. Accordingly, the first part, component, region, layer or section described below may be referred to as the second part, component, region, layer or section within a scope that does not exceed the scope of the present disclosure.

Also, unless specifically stated otherwise, % means mol %, and if no unit is specified separately, the unit referring to mol is omitted.

In this specification, the term “combination thereof(s)” described in a Markush format expression means one or more mixtures or combinations selected from the group consisting of components described in the Markush format expression and means including one or more selected from the group consisting of the components.

Below, an implementation example of the present disclosure will be described in detail. However, this is provided as an example and the present disclosure is not limited thereby, and the present disclosure is only defined by the scope of the claims described below.

### Electrolyte Additive for Lithium Rechargeable Battery

As mentioned above, various electrolyte additives are being developed to delay degradation, but there is a problem that the instability of the protective layer causes continuous consumption of the additive, increases electrode resistance, inhibits output characteristics, and degrades durability performance.

However, the present embodiment overcomes the limitations of existing additives by including an electrolyte additive having a permittivity in a specific range and containing an alkyl group of C1 to C10 substituted with one or more halogens.

More specifically, an electrolyte additive for a lithium rechargeable battery can solve this problem by having a permittivity of less than 1.0 F/m and a structure represented by the following formula 1.

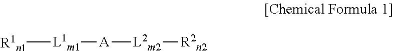

In Chemical Formula I above,
A is C or Si,
R¹ is a C1 to C10 alkyl group substituted with one or more halogens,
R² is hydrogen, deuterium, halogen, substituted or unsubstituted C1 to C10 alkyl group, substituted or unsubstituted C1 to C10 heteroalkyl group, substituted or unsubstituted C3 to C10 cycloalkyl group, substituted or unsubstituted C2 to C10 heterocycloalkyl group, substituted or unsubstituted C2 to C10 alkenyl group, substituted or unsubstituted C3 to C10 cycloalkenyl group, substituted or unsubstituted C1 to C10 heteroalkenyl group, substituted or unsubstituted C2 to C10 heterocycloalkenyl group, substituted or unsubstituted C2 to C10 alkynyl group, substituted or unsubstituted C3 to C10 cycloalkynyl group, substituted or unsubstituted C1 to C10 heteroalkynyl group, substituted or unsubstituted C2 to C10 heterocycloalkynyl group, substituted or unsubstituted C6 to C10 aryl group, substituted or unsubstituted C2 to C10 heteroaryl group, substituted or unsubstituted C1 to C10 alkoxy group, substituted or unsubstituted C2 to C10 aryloxy group, or any combination thereof,
L¹ and L² are independently, directly bonded, substituted or unsubstituted C1 to C10 alkyl groups,
n1 and n2 are independently integers between 1 and 3,
m1 and m2 are, independently of each other, integers between 1 and 100.

Specifically, in the above formula 1,
A is C or Si,
R¹ is a C1 to C6 alkyl group substituted with 1 to 3 halogens,
R² is hydrogen, deuterium, halogen, substituted or unsubstituted C1 to C6 alkyl group, substituted or unsubstituted C1 to C6 heteroalkyl group, substituted or unsubstituted C3 to C6 cycloalkyl group, substituted or unsubstituted C2 to C6 heterocycloalkyl group, substituted or unsubstituted C2 to C6 alkenyl group, substituted or unsubstituted C3 to C6 cycloalkenyl group, substituted or unsubstituted C1 to C6 heteroalkenyl group, substituted or unsubstituted C2 to C6 heterocycloalkenyl group, substituted or unsubstituted C2 to C6 alkynyl group, substituted or unsubstituted C3 to C6 cycloalkynyl group, substituted or unsubstituted C1 to C6 heteroalkynyl group, substituted or unsubstituted C2 to C6 heterocycloalkynyl group, substituted or unsubstituted C6 to C10 aryl group, substituted or unsubstituted C2 to C6 heteroaryl group, substituted or unsubstituted C1 to C6 alkoxy group, substituted or unsubstituted C2 to C6 aryloxy group, or any combination thereof,
n1 and n2 can be independently integers from 1 to 3.

More specifically,
A is C or Si,
R¹ is a C1 to C3 alkyl group substituted with 1 to 3 halogens,
R² is hydrogen, deuterium, halogen, a substituted or unsubstituted C1 to C3 alkyl group, a substituted or unsubstituted C1 to C3 heteroalkyl group, a substituted or unsubstituted C3 to C6 cycloalkyl group, a substituted or unsubstituted C2 to C6 heterocycloalkyl group, a substituted or unsubstituted C2 to C3 alkenyl group, a substituted or unsubstituted C3 to C6 cycloalkenyl group, a substituted or unsubstituted C1 to C3 heteroalkenyl group, a substituted or unsubstituted C2 to C6 heterocycloalkenyl group, a substituted or unsubstituted C2 to C3 alkynyl group, a substituted or unsubstituted C3 to C6 cycloalkynyl group, a substituted or unsubstituted C1 to C3 heteroalkynyl group, a substituted or unsubstituted C2 to C6 heterocycloalkynyl group, a substituted or unsubstituted C6 to C10 aryl group, a substituted or unsubstituted C2 to C6 a heteroaryl group, a substituted or unsubstituted C1 to C3 alkoxy group, a substituted or unsubstituted C2 to C6 aryloxy group, or any combination thereof,
n1 and n2 can be independently integers from 1 to 3.

More specifically,
A is C or Si,
R¹ is a C1 to C3 alkyl group substituted with 2 to 3 halogens,
R² is hydrogen, deuterium, halogen, a substituted or unsubstituted C1 to C3 alkyl group, a substituted or unsubstituted C1 to C3 heteroalkyl group, a substituted or unsubstituted C3 to C6 cycloalkyl group, a substituted or unsubstituted C2 to C6 heterocycloalkyl group, a substituted or unsubstituted C2 to C3 alkenyl group, a substituted or unsubstituted C3 to C6 cycloalkenyl group, a substituted or unsubstituted C1 to C3 heteroalkenyl group, a substituted or unsubstituted C2 to C6 heterocycloalkenyl group, a substituted or unsubstituted C2 to C3 alkynyl group, a substituted or unsubstituted C3 to C6 cycloalkynyl group, a substituted or unsubstituted C1 to C3 heteroalkynyl group, a substituted or unsubstituted C2 to C6 heterocycloalkynyl group, a substituted or unsubstituted C6 to C10 aryl group, a substituted or unsubstituted C2 to C6 a heteroaryl group, a substituted or unsubstituted C1 to C3 alkoxy group, a substituted or unsubstituted C2 to C6 aryloxy group, or any combination thereof,
L¹ and L² are independently, directly bonded or unsubstituted C1 to C10 alkyl groups,
n1 and n2 can be independently integers from 1 to 3.

More specifically,
A is C or Si,
R¹ is —CF₃ or —CF₂.
R² is hydrogen, deuterium, halogen, unsubstituted C1 to C3 alkyl group, unsubstituted C1 to C3 heteroalkyl group, unsubstituted C3 to C6 cycloalkyl group, unsubstituted C2 to C6 heterocycloalkyl group, unsubstituted C2 to C3 alkenyl group, unsubstituted C3 to C6 cycloalkenyl group, unsubstituted C1 to C3 heteroalkenyl group, unsubstituted C2 to C6 heterocycloalkenyl group, unsubstituted C2 to C3 alkynyl group, unsubstituted C3 to C6 cycloalkynyl group, unsubstituted C1 to C3 heteroalkynyl group, unsubstituted C2 to C6 heterocycloalkynyl group, unsubstituted C6 to C10 aryl group, unsubstituted C2 to C6 heteroaryl group, unsubstituted C1 to C3 alkoxy group, substituted or unsubstituted C2 to C6 aryloxy group, or any combination thereof,
L¹ and L² are independently, directly bonded or unsubstituted C1 to C6 alkyl groups,
n1 and n2 can be independently integers from 1 to 3.

More specifically,
A is C or Si,
R¹ is —CF₃ or —CF₂,
R² is hydrogen, halogen, unsubstituted C1 to C3 alkyl group, unsubstituted C2 to C3 alkenyl group, unsubstituted C2 to C3 alkynyl group, or any combination thereof,
L¹ and L² are independently, directly bonded or unsubstituted C1 to C3 alkyl groups,
n1 is an integer of 1 or 2,
n2 is an integer from 1 to 3.

Or, A is Si,
R¹ is —CF₃ or —CF₂,
R² is —CF₃ or —CF₂,
L¹ and L² are independently, directly bonded or unsubstituted C1 to C3 alkyl groups,
n1 is 1,
n2 can be 3.

The term “halogen” is used in a general sense to refer to a fluorine (F), chlorine (Cl), bromine (Br) or iodine (I) substituent.

The term “alkyl”, unless specifically defined otherwise, denotes a linear or branched, fully saturation hydrocarbon group, for example, C3-C5 alkyl refers to a saturation hydrocarbon group in which three to five carbons are connected by a single bond and only hydrogen is substituted, such as methyl (Me), ethyl (Et), propyl (including n-propyl and isopropyl), butyl (including n-butyl, isobutyl, s-butyl, and t-butyl), pentyl (including n-pentyl, isopentyl (Isopentyl), and neopentyl (neopentyl)).

When referring to C1-C10 alkyl substituted with one or more halogens in this specification, halogen may mean one or more halogen elements selected from F, Cl, Br, and I, and one or more may mean C1-C10 alkyl substituted with 1-5, 1-4, 1-3, 2 or 3 of functional group.

“Heteroalkyl” means an alkyl group as referred to herein but where one or more of the atoms of the moiety is a heteroatom selected, independently from N, O, or S and includes alkyoxy groups such as C1-12 alkoxy including methoxy, ethoxy, butoxy and the like, alkylamine groups include C1-12alkylamines, alkylsulfides including C1-12alkylsulfides and alkylsulfones including C1-12 alkylsulfones.

“Alkenyl” refers to an optionally substituted straight-chain or optionally substituted branched-chain hydrocarbon monoradical having one or more carbon-carbon double-bonds and having from two to about ten carbon atoms, or two to about six carbon atoms. The group may be in either the cis or trans conformation about the double bond(s) and should be understood to include both isomers. Examples include but are not limited to ethenyl (—CH═CH₂), 1-propenyl (—CH₂CH═CH₂), isopropenyl [—C(CH₃)═CH₂], butenyl, 1,3-butadienyl and the like.

“Heteroalkenyl” means an alkenyl group as referred to herein but where one or more of the atoms of the moiety is a heteroatom selected, independently from N, O, or S.

“Alkynyl” refers to an optionally substituted straight-chain or optionally substituted branched-chain hydrocarbon monoradical having one or more carbon-carbon triple-bonds and having for example from two to about ten carbon atoms, more preferably from two to about six carbon atoms. Examples include, but are not limited to ethynyl, 2-propynyl, 2-butynyl, 1,3-butadiynyl and the like.

“Heteroalkynyl” means an alkynyl group as referred to herein but where one or more of the atoms of the moiety is a heteroatom selected, independently from N, O, or S.

The term “alkoxy” refers to a substituent in which a linear or branched saturation hydrocarbon of a single bond is connected through an oxygen group. Examples include methoxy, ethoxy, propoxy, n-butoxy, tert-butoxy, and 1-methylpropoxy.

The term “cycloalkyl” refers to a cyclic, single-bonded saturation hydrocarbon group, and when it says C3-C6cycloalkyl, it means a cyclic saturation hydrocarbon group in which three to six carbons are connected to form a ring, but only hydrogens are substituted, and examples include cyclopropyl, cyclobutyl, cyclopentyl, and cyclohexyl.

The term “cycloalkenyl” refers to cyclic or polycyclic hydrocarbon groups of for example from 3 to 13 carbon atoms, preferably from 5 to 8 carbon atoms, containing one or more double bonds, including one or more carbon-carbon double bonds. Cycloalkenyl groups may be substituted or unsubstituted. Exemplary cycloalkenyl groups include, without limitation, cyclopentenyl, cyclohexenyl, and cyclooctenyl.

The term “cycloalkynyl” refers to cyclic or polycyclic hydrocarbon groups of for example from 5 to 13 carbon atoms containing one or more triple bonds typically carbon-carbon triple bonds. Cycloalkynyl groups may be substituted or unsubstituted.

“Cycloalkylene” means a divalent, saturated or partially unsaturated, monocyclic, bicyclic or polycyclic ring assembly. (C_{X})cycloalkylene and (C_{X-Y})cycloalkylene are typically used where X and Y indicate the number of carbon atoms in the ring assembly. In particular embodiments, “cycloalkylene,” either alone or represented along with another radical, can be a (C₃₋₁₄)cycloalkylene, a (C₃₋₁₀)cycloalkylene, a (C₃₋₇)cycloalkylene, a (C₈₋₁₀)cycloalkylene or a (C₅₋₇)cycloalkylene. Alternatively, “cycloalkylene,” either alone or represented along with another radical, can be a (C₅)cycloalkylene, a (C₆)cycloalkylene, a (C₇)cycloalkylene, a (C₈)cycloalkylene, a (C₉)cycloalkylene or a (C₁₀)cycloalkylene.

The term “heterocycloalkyl”, unless specifically defined otherwise, refers to a cyclic, fully saturated or partially unsaturated hydrocarbon group containing one or more heteroatoms, such as N, O, or S, such as aziridinyl, pyrrolidinyl, piperidinyl, oxopiperidinyl, morpholinyl, piperazinyl, oxopiperazinyl, morpholinyl, thiomorpholinyl, azepanyl, diazepanyl, oxazepanyl, thiazepanyl, dioxothiazepanyl, azocanyl, tetrahydrofuranyl, tetrahydropyranyl, oxazolelidinyl, dioxanyl, dioxolanyl, dihydro furanyl, and dihydro pyranyl. The number of heteroatoms forming the ring can be, for example, 1 to 5, 1 to 4, 1 to 3, 1 to 2 or 1, and the types of heteroatoms are selected from N, O and S unless otherwise defined, and the remainder are composed of carbon.

The term “aryl” refers to a functional group obtained by removing one hydrogen atom from an aromatic hydrocarbon, and includes single rings, double or more aromatic hydrocarbon functional groups formed by fusion, and C6-C10 aryl refers to a completely unsaturated hydrocarbon single or fused double ring compound having 6 to 10 carbon atoms that satisfies Hückel's rule and contains phenyl and naphthyl groups.

The term “aryloxy” refers to a substituent in which an aryl group is connected through an oxygen group. Examples include phenoxy, ring-substituted phenoxy, and naphyloxy.

The term “heteroaryl”, unless otherwise defined, refers to an aromatic cyclic compound containing one or more heteroatoms such as N, O, or S, and the number of rings can include all cyclic compounds formed by fusion of 1, 2, or 3 rings, and when 2 or more rings are fused, not all of the rings need to contain heteroatoms, and only some of the rings can contain heteroatoms, and the number of heteroatoms forming the ring can be 1 to 5, 1 to 4, 1 to 3, 1 to 2, or 1, and the remainder is composed of carbon, and includes pyridyl, pyrroleyl, pyridinyl, furanyl, quinolidinyl, indolyl, pyrimidinyl, imidazoleyl, 1,2,4-triazoleyl, tetrazoleyl, pyranyl, thiophenyl, thiazolyl, dibenzothiphenyl, dibenzofuranyl, dibenzoselenophene, thiophene, benzofuran, benzothiophenyl, benzoselenophenyl, carbazolyl, indolocarbazolyl, pyridylindolyl, pyrrolodipyridinyl, pyrazolely, imidazolely, triazolely, oxazolyl, thiazolyl, oxadiazolely, oxatriazolely, dioxazolyl, thiadiazolyl, pyridinyl, pyridazinyl, pyrazinyl, triazinyl, oxazinyl, oxathiazinyl, oxadiazinyl, indolyl, benzimidazolely, indazolyl, indoxazinyl, benzoxazolyl, benzisoxazolely, benzothiazolely, quinolinyl, isoquinolinyl, cinolinyl, quinazolinyl, quinoxalinyl, naphthyridinyl, phthrazinyl, pteridinyl, xanthenyl, Examples include arcridinyl, phenazinyl, phenothiazinyl, phenoxazinyl, benzopyridinyl, furodipyridinyl, benzothienopyridinyl, thienodipyridinyl, benzoselenophenopyridinyl, and celenophenodipyridinyl, and a 5-6 membered heteroaryl refers to a heteroaryl having 5 or 6 atoms forming the ring, and the number of heteroatoms is 1-3, 1-2, or 1, and can include, for example, pyrroleyl, pyrazoleyl, pyridinyl, pyrimidinyl, puryl, thiophenyl, triazoleyl, etc.

“Heterocycloalkenyl” refers to a stable 3- to 24-membered partially unsaturated ring radical comprising 2 to 23 carbon atoms and from one to 8 heteroatoms selected from the group consisting of nitrogen, oxygen, phosphorous and sulfur, more typically one or more N, O or S. In some embodiments, the heterocycloalkenyl comprises one to three heteroatoms selected from the group consisting of nitrogen, oxygen, and sulfur. In some embodiments, the heterocycloalkenyl comprises one to three heteroatoms selected from the group consisting of nitrogen and oxygen. In some embodiments, the heterocycloalkenyl comprises one to three nitrogens. In some embodiments, the heterocycloalkenyl comprises one or two nitrogens. In some embodiments, the heterocycloalkenyl comprises one nitrogen. Unless stated otherwise specifically in the specification, the heterocycloalkenyl may be a monocyclic, bicyclic, tricyclic or tetracyclic ring system, which may include fused (when fused with an aryl or a heteroaryl ring, the heterocycloalkyl is bonded through a non-aromatic ring atom) or bridged ring systems; and the nitrogen, carbon or sulfur atoms in the heterocycloalkenyl radical may be optionally oxidized; the nitrogen atom may be optionally quaternized. Representative heterocycloalkenyls include, but are not limited to, heterocycloalkenyls having from two to ten carbon atoms (C₂-C₁₀ heterocycloalkenyl), from two to eight carbon atoms (C₂-C₈ heterocycloalkenyl), from two to seven carbon atoms (C₂-C₇ heterocycloalkenyl), from two to six carbon atoms (C₂-C₆ heterocycloalkenyl), from two to five carbon atoms (C₂-C₈ heterocycloalkenyl), or two to four carbon atoms (C₂-C₄ heterocycloalkenyl). Examples of such heterocycloalkenyls include, but are not limited to, 2,3-dihydro-1H-pyrrole, 1,2,3,6-tetrahydropyridine, 1,2-dihydropyridine, 1,2,3,4-tetrahydropyrazine, and 3,4-dihydro-2H-1,4-oxazine. Unless otherwise noted, heterocycloalkenyls have from 2 to 10 carbons in the ring. It is understood that when referring to the number of carbon atoms in a heterocycloalkenyl, the number of carbon atoms in the heterocycloalkenyl is not the same as the total number of atoms (including the heteroatoms) that make up the heterocycloalkenyl (i.e. skeletal atoms of the heterocycloalkenyl ring). In some embodiments, the heterocycloalkenyl is a 3- to 8-membered heterocycloalkenyl. In some embodiments, the heterocycloalkenyl is a 3- to 7-membered heterocycloalkenyl. In some embodiments, the heterocycloalkenyl is a 3- to 6-membered heterocycloalkenyl. In some embodiments, the heterocycloalkenyl is a 4- to 6-membered heterocycloalkenyl. In some embodiments, the heterocycloalkenyl is a 5- to 6-membered heterocycloalkenyl.

“Heterocycloalkynyl” refers to a stable 3- to 24-membered comprising or more carbon-carbon triple bonds between ring members and within a ring radical comprising 2 to 23 carbon atoms and from one to 8 heteroatoms selected from the group consisting of nitrogen, oxygen, phosphorous and sulfur, more typically one or more N, O or S.

In the present disclosure, “substituted by one or more substituents” or “a substituted” group mean substituted by 1, 2, 3, one to three substituents from e.g. among the listed substituents. Thus, for example a “substituted” moiety as referred to above refers to a group that is substituted at one or more available by a non-hydrogen substituent such as hydroxyl; halogen; halo-substituted alkyl such as —CCl₃, —CBr₃, —CF₃, —Cl₃, —CHCl₃, —CHBr₂, —CHF₂, —CHI₂, —CH₂Cl, —CH₂Br, —CH₂F, —CH₂I; —CN; —OH; —NH₂; —COOH; —CONH₂; —NO₂; —SH; —SO₃H; —SO₄H; —SO₂NH₂; —NHNH₂; —ONH₂; —NHC(O)NHNH₂; —NHC(O)NH₂; —NHSO₂H; —NHC(O)H, —NHC(O)OH, —NHOH, —OCCl₃, —OCH₂F₃, —OCH₂Br₃, —OCl₃, —OCH₂CH₃, —OCHBr₂, —OCHI₂, —OCHF₂, —OCH₂Cl, —OCH₂Br, —OCH₂I, —OCH₂F, —N₃, unsubstituted alkyl (e.g., C₁-C₁₂ alkyl, C₁-C₆ alkyl, or C₁-C₄ alkyl), unsubstituted heteroalkyl (e.g., 2 to 8 membered heteroalkyl, 2 to 6 membered heteroalkyl, or 2 to 4 membered heteroalkyl), unsubstituted cycloalkyl (e.g., C₃-C₁₂ cycloalkyl, C₃-C₈ cycloalkyl, or C₃-C₆ cycloalkyl), unsubstituted heterocycloalkyl (e.g., 3 to 8 membered heterocycloalkyl, 3 to 6 membered heterocycloalkyl, or 5 to 6 membered heterocycloalkyl), unsubstituted aryl (e.g., C₆-C₁₀ aryl, C₁₀ aryl, or phenyl), or unsubstituted heteroaryl (e.g., 5 to 10 membered heteroaryl, 5 to 9 membered heteroaryl, or 5 to 6 membered heteroaryl), which may be further optionally substituted.

Specifically, an electrolyte additive for a lithium rechargeable battery according to an embodiment may be represented by the following formula 2 or 3 and may be an electrolyte additive for a lithium rechargeable battery having a permittivity of 1.0 F/m or less.

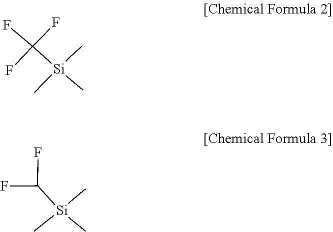

At this time, the electrolyte additive described above may be a compound having a LUMO (Lowest Unoccupied Molecular Orbital) energy level of −0.7 eV or higher.

Additionally, the electrolyte additive described above may be a compound having a HOMO (Highest Occupied Molecular Orbital) energy level of −6.9 eV or less.

When the energy level range is satisfied individually or simultaneously, the electrochemical effects, such as durability, of a lithium rechargeable battery including an electrolyte additive for the lithium rechargeable battery as in the present embodiment can be sustained.

### Electrolyte for Lithium Rechargeable Battery

The electrolyte for a lithium rechargeable battery may include the additive described above; and a linear or cyclic ether solvent or sulfamoyl solvent as the main or primary solvent.

The ether solvent may contain one or two oxygen atoms and is specifically 1,2-dimethoxyethane.

The solvent component may include a sulfamoyl solvent containing fluorine as a substituent, including where one or more fluorine-substituted sulfonyl solvents are a primary or main portion of the solvent component as disclosed herein. As disclosed herein, a solvent component of the electrolyte may be composed of a single solvent, or a blend of two or more distinct solvents. Preferably, at least one solvent of the solvent component is a fluorine-substituted sulfonyl solvent, more preferably one or more fluorine-substituted sulfonyl solvent is a primary or main portion of the solvent component.

Additionally, the sulfamoyl solvent may contain a fluorosulfonyl group represented by the following formula 4.

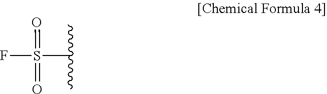 [SMILES: *S(=O)(=O)F]

Additionally, the sulfamoyl solvent may be a solvent represented by the following formula 5.

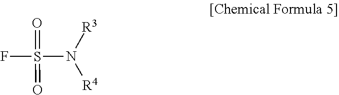

The R³ and R⁴ can each be independently substituted with one functional group selected from the group consisting of hydrogen and an unsubstituted C1-10 alkyl group.

The additive comprises a C1 to C10 alkyl group substituted with two to three halogens, more specifically a C1 to C10 alkyl group substituted with two halogens, or —CF2, and the mole ratio of the main solvent to the additive (main solvent mol:additive mol) can be 0.99:0.01 to 0.95:0.05, 0.975:0.025 to 0.95:0.05, or 0.975:0.025 to 0.945:0.045.

When the mole ratio range of the main solvent to the additive is satisfied, the electrochemical characteristics such as ion conductivity or durability of a lithium rechargeable battery including the electrolyte additive for the lithium rechargeable battery as in the present embodiment can be improved.

### Lithium Rechargeable Battery

A lithium rechargeable battery includes a positive electrode; a negative electrode; and a separator interposed between the positive electrode and the negative electrode; and may include any one of the electrolytes described above.

As described above, the lithium rechargeable battery according to the present disclosure can have excellent ion conductivity, improved durability, and excellent electrochemical characteristics, and therefore is useful in portable devices such as portable phone, laptop, and digital cameras, and electric vehicles such as hybrid electric vehicles (hybrid electric vehicles, HEVs).

The following examples illustrate the present disclosure in more detail. However, the following embodiment is only a preferable embodiment and the present disclosure is not limited to the following embodiment.

### Embodiment 1

First, an amount equivalent to 2.925 moles of N,N-dimethylsulfamoyl fluoride (DMSF) as the main solvent was added to the container. After that, 0.075 mole of TMS-CF3 was added as an electrolyte additive, and 1.0 mole of lithium bis(fluorosulfonyl)imide (LiF₂NO₄S₂, LiFSI) was added as a lithium salt, and stirring was continuously performed in a stirrer for 24 hours to dissolve the salt (@30° C.). At this time, the dissolution was confirmed to be complete by checking whether the salt became transparent.

### Embodiment 2

An electrolyte was prepared in the same manner as in embodiment 1, except that 2.97 moles of DMSF were added as the main solvent and 0.03 moles of TMS-CF3 were added as the electrolyte additive.

### Embodiment 3

An electrolyte was prepared in the same manner as in embodiment 1, except that 2.925 moles of DMSF were added as the main solvent and 0.075 moles of TMS-CF2 were added as the electrolyte additive.

### Comparative Example 1

An electrolyte was prepared in the same manner as in embodiment 1, except that an amount equivalent to 3.0 mole of DMSF was added as the main solvent and no electrolyte additive was added.

### Comparative Example 2

An electrolyte was prepared in the same manner as in embodiment 1, except that 2.925 moles of DMSF were added as the main solvent and 0.075 moles of TTE were added as the electrolyte additive.

### Comparative Example 3

An electrolyte was manufactured in the same manner as in embodiment 1, except that 2.925 moles of DMSF were added as the main solvent and 0.075 moles of FEC were added as the electrolyte additive.

### Comparative Example 4

An electrolyte was prepared in the same manner as in embodiment 1, except that 2.985 moles of DMSF were added as the main solvent and 0.015 moles of TMS-CF3 were added as the electrolyte additive.

### Comparative Example 5

An electrolyte was prepared in the same manner as in embodiment 1, except that 2.97 moles of DMSF were added as the main solvent and 0.03 moles of TMS-CF2 were added as the electrolyte additive.

The following Table 1 is a table that summarizes the contents of the main solvent and electrolyte additives in the entire electrolyte of the aforementioned embodiment and comparative example. As described above, Comparative Example 1 used only the main solvent without the addition of electrolyte additive.

TABLE 1

| | Main solvent | | Electrolyte additive | |
|---|---|---|---|---|
| | | Content | | Content |
| | | [mol %] | | [mol %] |
| | | in total | | in total |
| | material | electrolyte | material | electrolyte |
| embodiment1 | DMSF | 97.5 | TMS-CF3 | 2.5 |
| embodiment2 | DMSF | 99.0 | TMS-CF3 | 1.0 |
| embodiment3 | DMSF | 97.5 | TMS-CF2 | 2.5 |
| Comparative | DMSF | 100.0 | — | — |
| Example 1 | | | | |
| Comparative | DMSF | 97.5 | TTE | 2.5 |
| Example2 | | | | |
| Comparative | DMSF | 97.5 | FEC | 2.5 |
| Example3 | | | | |
| Comparative | DMSF | 99.0 | TMS-CF3 | 0.5 |
| Example4 | | | | |
| Comparative | DMSF | 99.5 | TMS-CF2 | 1.0 |
| Example5 | | | | |
| Comparative | DMSF | 95.0 | TMS-CF3 | 5.0 |
| Example6 | | | | |
| Comparative | DMSF | 95.0 | TMS-CF2 | 5.0 |
| Example7 | | | | |

The chemical names in Table 1, structural formulas, and permittivity of the materials are as shown in the following Table 2.

TABLE 2

| | | | Permittivity |
|---|---|---|---|
| material | Compound | Structure | ϵ [F/m] |
| DMSF | N,N-dimethylsulfamoyl fluoride | 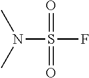 | 52.5 |
| TMS-CF3 | Trimethyl(trifluoromethyl)silane | 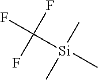 | 0 |
| TMS-CF2 | (Difluoromethyl)trimethylsilane | 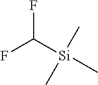 | 0 |
| TTE | 1,1,2,2-Tetrafluoroethyl-2,2,3,3- Tetrafluoropropyl ether | 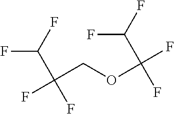 [SMILES: FC(F)C(F)(F)COC(F)(F)C(F)F] | 1.1 |
| FEC | Fluoroethylene carbonate | 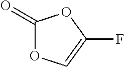 | 107 |
| DOL | 1,3-dioxolane | 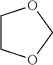 | 2.3 |

At this time, materials showing permittivity of less than 1.0 F/rn were marked as 0 F/m in Table 2. This means that the material hardly reacts to the electric field.

### Experimental Example 1: Evaluation and Analysis of Endurance Performance of Li/NMC Coin Cells

The durability performance of Li/NMC coin cells was evaluated using the embodiment and comparative example electrolytes.

### (1) Manufacturing Coin Cells for Durability Performance Evaluation

First, a coin cell R2032 type unit cell was manufactured as shown in FIG. 3. Specifically, it includes the NMC811 (LiNi_{0.80}Co_{0.10}Mn_{0.10}O₂, 4.0 mAh/cm², 14 pi) positive electrode, the lithium thin film (20 μm on 100 μm Cu, 16 pi) negative electrode, and the PE (14 μm, 18 pi) separator with silica coating on both sides.

The liquid electrolytes used were the electrolytes manufactured in the embodiment and comparative example, respectively. Using a micropipette, a small amount of electrolyte was injected into the separator of the cell of the configuration at 1.5 g/Ah to 3.0 g/Ah. Specifically, the 1/3C-rate evaluation is for a 1.5 g/Ah solution, and includes the evaluations of embodiment 1, embodiment 2, embodiment 3, Comparative Example 3, Comparative Example 4, Comparative Example 5, and Comparative Example 1. Meanwhile, the 1C-rate evaluation is 3.0 g/Ah, and the evaluations of Comparative Example 2 and Comparative Example 1 correspond to this. For reference, it was confirmed that there was no change in durability trend according to difference in the amount of the main fluid in the given main fluid range.

### (2) Measurement of Average Voltage and Capacity Changes According to Charge/Discharge (Charge-Discharge) Performance

Among the coin cells manufactured using the above method, the change in average voltage and capacity of the coin cell according to charge/discharge performance was confirmed through the coin cell using Comparative Example 1 electrolyte that does not contain electrolyte additive.

After 5 hours of elapsed time from the manufacture of the coin cell, the electrode was activated by a 2-cycle of CC (constant current)/CC charge/discharge at C/10-rate, followed by a 1C-rate CC-CV (constant voltage) charge and a 1C-rate CC discharge condition. At this time, the CV charge section starts when the C/20 current is reached, and the voltage is set to 4.25 V according to the evaluation condition.

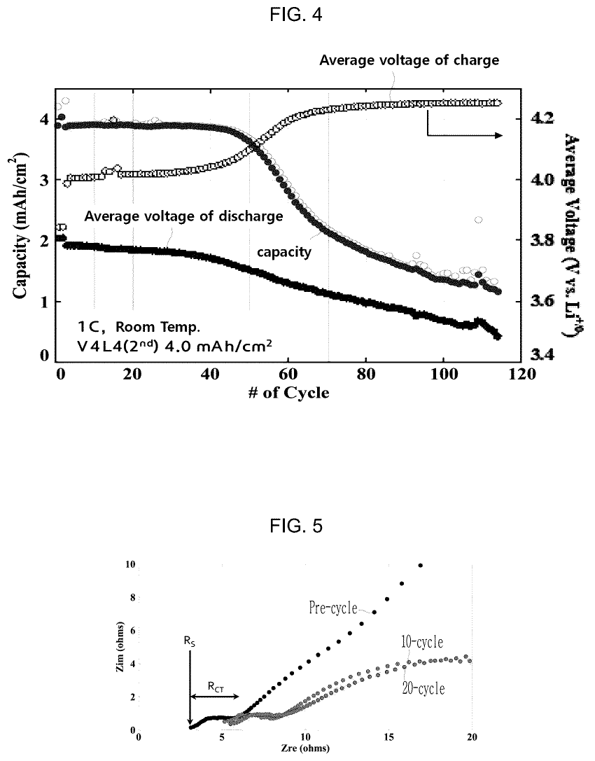

As can be seen in FIG. 4, as the charge/discharge cycle increases, the charge average voltage increases and the discharge overvoltage decreases, indicating an increase in overvoltage and a decrease in capacity. Specifically, the charge average voltage of the initial cycle was 4.0 V and the initial capacity was 4.0 mAh/cm², but after 40 charge/discharge cycles, it was confirmed that the charge average voltage increased rapidly, and the capacity also decreased rapidly. Particularly after 57 cycles, the average voltage exceeded 4.2 V and the capacity also decreased to less than 3.2 mAh/cm², which corresponds to less than 80% of the initial capacity. Through this, it was confirmed that degradation occurred due to an increase in excessive voltage, i.e., an increase in resistance.

### (3) Measurement of Electrochemical Impedance Spectroscopy (EIS) by Cycle of Charge/Discharge

Among the coin cells manufactured using the above method, the factor that increases the resistance within the electrode was identified through a coin cell using Comparative Example 1 electrolyte that does not contain an electrolyte additive.

After 5 hours of elapsed time from the coin cell manufacturing, the electrode was activated with a 2-cycle CC/CC charge/discharge at C/10-rate, and then a charge/discharge was performed under a 1C-rate CC-CV charge and a 1C-rate CC discharge condition. At this time, the CV charge section starts when the C/20 current is reached, and the voltage is set to 4.25 V according to the evaluation condition.

Resistance was measured at 25° C. using an impedance analyzer (PMC CHS08A-PMC1000, Princeton Applied Research) according to the 2-probe method. The amplitude was ±5 mV, and the frequency range was 0.1 Hz to 1 MHz.

The polar coordinate diagram (Nyquist plot) for the impedance measurement result is shown in FIG. 5. The x-axis represents the real part Ze (real number) of the composite impedance, and the y-axis represents the imaginary part Zim (imaginary number) of the composite impedance.

In FIG. 5, the resistance of the coin cell is determined by the position and size of the semicircle. The left x-axis section of the semicircle represents Rₛ, the Ohm resistance of the coin cell's internal electrolyte, and the difference between the left x-axis section and the right x-axis section of the semicircle represents R_{CT}, the Ohm resistance of the coin cell's internal electrode.

The larger the voltage/current change cycle, the more dominant the effect on the battery characteristics. Specifically, the Rₛ and R_{ct} values increase as the performance of the battery deteriorates due to aging. Therefore, this becomes a reference for judging the battery's SoH (State of Health).

The data of Rₛ and R_{CT} measured for each charge/discharge number are shown in the following Table 3.

TABLE 3

| | Pre-cycle | 10-cycle | 20-cycle | 50-cycle | 70-cycle |
|---|---|---|---|---|---|
| R_{S} [ohms] | 3.06 | 5.17 | 5.57 | 6.69 | 7.55 |
| R_{CT} [ohms] | 3.27 | 3.28 | 3.25 | 3.27 | 3.26 |

As shown in Table 3 and FIG. 5, no change in the value of R_{CT} was observed as the number of charge/discharge cycles increased, whereas the value of Rₛ was found to increase as the number of charge/discharge cycles increased. Specifically, it was confirmed that the Rₛ value increased by approximately 2.19 times after performing 50 charge/discharge cycles.

That is, it was confirmed that the resistance increased in the electrolyte, not the electrode, and thus it was found that it was necessary to prevent the increase in resistance within the electrolyte.

### (4) Measurement of Nuclear Magnetic Resonance Spectrometry (NMR) by Charge/Discharge Cycle

Among the coin cells manufactured using the above method, the factor that increases the resistance of the electrolyte was identified through a coin cell using Comparative Example 1 electrolyte that does not contain an electrolyte additive.

After 5 hours of elapsed time from the coin cell manufacturing, the electrode was activated with a 2-cycle CC/CC charge/discharge at C/10-rate, and then a charge/discharge was performed under a 1C-rate CC-CV charge and a 1C-rate CC discharge condition. At this time, the CV charge section starts when the C/20 current is reached, and the voltage is set to 4.25 V according to the evaluation condition.

The F¹⁷ element was measured at 500 MHz using a nuclear magnetic resonance spectrometer (Unity Inova 500 MHz-NMR from Varian Technology). The samples were collected by disassembling the coin cell containing 3.0 g/Ah sample solution and collecting the separator after performing 10, 30, 50, 100, and 150 cycles of charging and discharging. The separator was immersed in 1 mL of DME, and 50 μl of the solution was added to 500 μl of d⁶-DMSO solvent to prepare the sample.

An increase in resistance in the electrolyte may be due to a decrease in ion conductivity caused by the consumption of the electrolyte itself or partial consumption of the salt, and distinguishing between these is important in suggesting a strategy to improve the durability of the battery cell. Therefore, the cause of the increase in electrolyte resistance was confirmed through nuclear magnetic resonance spectroscopy analysis. In detail, the areas of the ¹⁷F peak of the salt (FSI) and the ¹⁷F peak of the solvent (DMSF) that can be observed in the nuclear magnetic resonance spectrogram of the electrolyte sample collected for each charge/discharge cycle were measured to analyze all remaining electrolyte components.

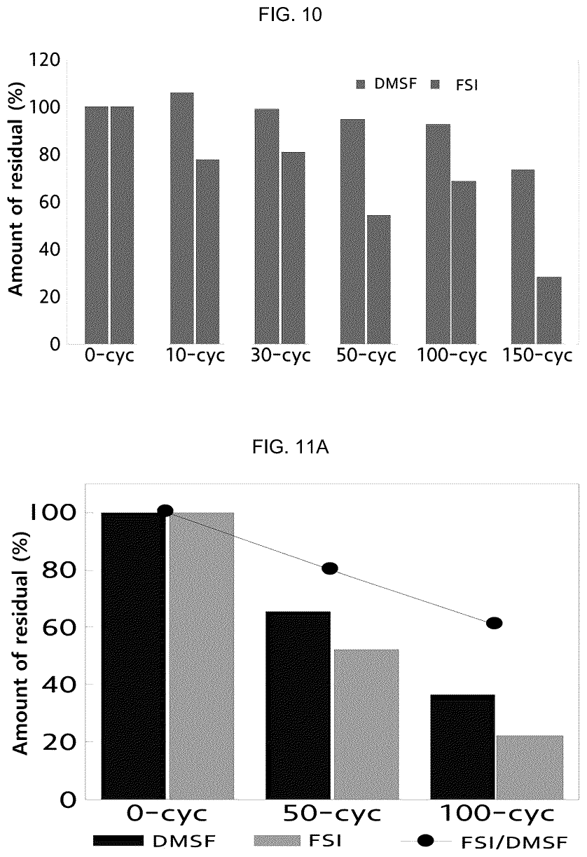

FIG. 10 is a graph comparing the amount of salt and solvent in a sample collected while the charge/discharge cycle was performed, with the amount of salt and solvent obtained from component analysis of a coin cell that had not started charge/discharge calculated as 100%. As charge/discharge is repeated, decomposition of the salt (FSI, right bar) progresses faster than decomposition of the solvent (DMSF, left bar).

### (5) Measurement of Linear Voltage-Current (Linear Sweep Voltammetry: LSV) by Salt Concentration

Among the coin cells manufactured by the following method, a coin cell was manufactured using an electrolyte in which the mole ratio of salt and solvent which is prepared by Comparative Example 1 without an electrolyte additive, was adjusted to 1:4 and 1:5, respectively. Through this, the electrolyte salt decomposition mechanism was identified.

To manufacture electrolytes with different LiFSI salt concentrations, DMSF was first added as the main solvent to each container in amounts of 3.0 mole, 4.0 mole, and 5.0 mole, respectively. Afterwards, 1.0 mole of LiFSI was added as lithium salt, and stirring was continuously performed for 24 hours in a stirrer to dissolve the salt (@30° C.). At this time, the dissolution was confirmed to be complete by checking whether the salt became transparent.

As prepared as above, LSV was measured in electrolytes with FSI (mol)/DMSF (mol) of 1/3, 1/4, and 1/5. Measurements were made at 25° C. using a voltage-current meter (PMC CHS08A-PMC1000, Princeton Applied Research) according to the two-probe methods. The injection speed was 0.5 mV/s. Measurements were performed at OCP −5.2 V vs. Li^{+/0} or OCP −0.1 V vs. Li^{+/0}.

The coin cell used a lithium thin film (20 μm on 100 μm Cu, 14 pi) reference electrode, a GF/C (18 pi) separator, a copper foil (100 μm, 16 pi) counter for reduction reaction analysis, and an aluminum foil (100 μm, 16 pi) counter for oxidation reaction analysis.

Salt depletion can occur as a result of reduction decomposition at the lithium negative electrode and oxidation decomposition at the positive electrode. The environment in which anions are particularly susceptible to oxidation is an issue that must be resolved in high voltage batteries. The DMSF solvent in Comparative Example 1 has the ability to weakly dissolve salts, which strengthens the bond between the lithium positive ion and the FSI negative ion, thereby weakening the negative ion characteristics of FSI, thereby delaying the oxidation decomposition of the salt.

This effect can be analyzed by measuring the current size at a specific voltage using the voltage current method, which reads the current for the chemical reaction that occurs when voltage is applied. In detail, the degree of oxidation or reduction of FSI is represented by the size of the current occurring at a voltage of 4.8 V vs. Li^{+/0} or 2.5 V vs. Li^{+/0}, respectively.

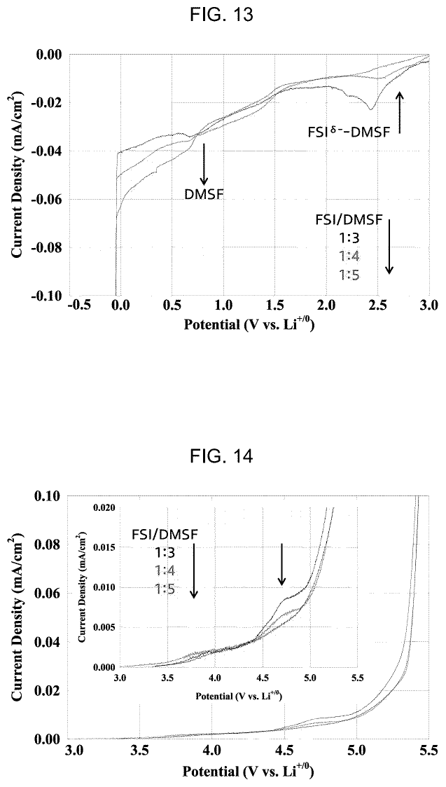

FIG. 14 is a linear voltage-current diagram for the oxidation reaction measured in a coin cell using electrolytes of comparative example 1 with mole ratios of salt to solvent of 1:3, 1:4, and 1:5. FIG. 13 is a linear voltage-current diagram for the reduction reaction measured in a coin cell using electrolytes of comparative example 1 with mole ratios of salt to solvent of 1:3, 1:4, and 1:5. As mentioned above, the use of DMSF solvent in Comparative Example 1 confirms that the oxidation decomposition of the FSI salt is minimal. However, the reduction decomposition current of the FSI salt shown in FIG. 13 is 6.7 times larger than the oxidation decomposition current in FIG. 14, indicating that reduction decomposition is occurring severely. Therefore, it is considered necessary to delay the reduction decomposition of FSI salts for a breakthrough in durability improvement.

Accordingly, the present disclosure aims to reduce reduction decomposition by using an electrolyte additive for a lithium rechargeable battery according to an embodiment.

### (6) Measurement of Capacity Retention Rate Change According to Charge/Discharge Performance

As described in the (1), the capacity retention rate change of the coin cell according to the charge/discharge performance was measured through the coin cell manufactured using an embodiment and a comparative example.

After 5 hours of coin cell manufacturing, the electrode was activated by 2-cycle CC (constant current)/CC charge/discharge at C/10-rate and then charge/discharge was performed under CC-CV (constant voltage) charge at 1C-rate to 1/3C-rate and CC discharge conditions at 1C to 1/3C-rate. At this time, the CV charge section starts when the C/20 current is reached, and the voltage is set to 4.25 V according to the evaluation condition.

Embodiment 1, embodiment 2, and Comparative Example 4 are cases where TMS-CF3 is added as an electrolyte additive to the main solvent DMSF.

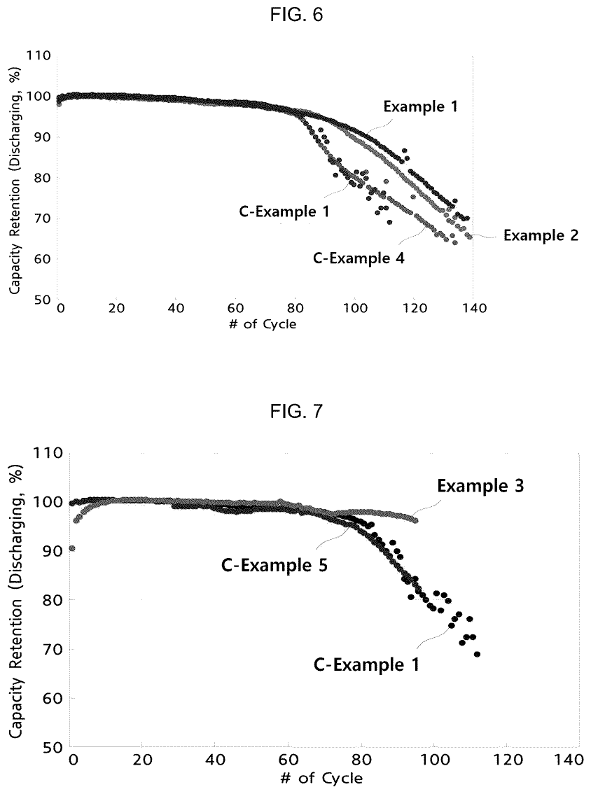

FIG. 6 is a drawing showing the result of repeatedly performing charge/discharge under CC-CV charge at 1/3C-rate and CC discharge at 1/3C-rate on coin cells containing 1.5 g/Ah of electrolyte manufactured by embodiment 1, embodiment 2, Comparative Example 1, and Comparative Example 4.

Referring to FIG. 6, in the case of embodiment 1 where the content of TMS-CF3 in the entire electrolyte is 2.5 mol %, it can be confirmed that the number of charge/discharge cycles for which the capacity retention rate becomes 80% increases by 23% compared to the case where Comparative Example 1 (123 cycle vs 100 cycle)

Referring to FIG. 6, in the case of embodiment 2 where the content of TMS-CF3 in the entire electrolyte is 1.0 mol %, it can be confirmed that the number of charge/discharge cycles for which the capacity retention rate becomes 80% is 120 cycles, which is a 20% increase compared to the case where Comparative Example 1 is 100 cycle.

Referring to FIG. 6, in the case of Comparative Example 5 where the content of TMS-CF3 in the entire electrolyte is 0.5 mol %, it can be confirmed that the durability improvement trend is insignificant when the number of charge/discharge cycles at which the capacity retention rate becomes 80% is 101 cycles compared to the case where Comparative Example 1 is 100 cycle.

When the content of TMS-CF3 in Comparative Example 6 increased to 5 mol %, it was difficult to implement because the salt did not dissolve, and it was confirmed that the durability improvement effect through the substantially delayed salt decomposition effect was not observed.

Embodiment 3 and Comparative Example 5 are cases where TMS-CF2 is added as an electrolyte additive to the main solvent DMSF.

FIG. 7 is a drawing showing the result of repeatedly performing charge/discharge under CC-CV charge at 1/3C-rate and CC discharge at 1/3C-rate on coin cells containing 1.5 g/Ah of electrolyte manufactured by Embodiment 3, Comparative Example 1, and Comparative Example 5.

Referring to FIG. 7, in the case of embodiment 3 where the content of TMS-CF2 in the entire electrolyte is 2.5 mol %, it can be confirmed that the capacity retention rate at 95 cycles is 96.2%, which is an increase of 11.9% compared to Comparative Example 1 where it is 84.3%.

Referring to FIG. 7, in the case of Comparative Example 5 where the content of TMS-CF2 in the entire electrolyte is 1.0 mol %, it can be confirmed that the capacity retention rate at 95 cycles is 83.2%, which shows a minimal durability improvement effect compared to Comparative Example 1 where it is 84.3%. That is, when the content of TMS-CF2 in the entire electrolyte is less than 1.0 mol %, it is difficult to achieve an effect of improving the durability of the battery.

Comparative Example 2 is a case where TTE is added as an electrolyte additive to the main solvent DMSF.

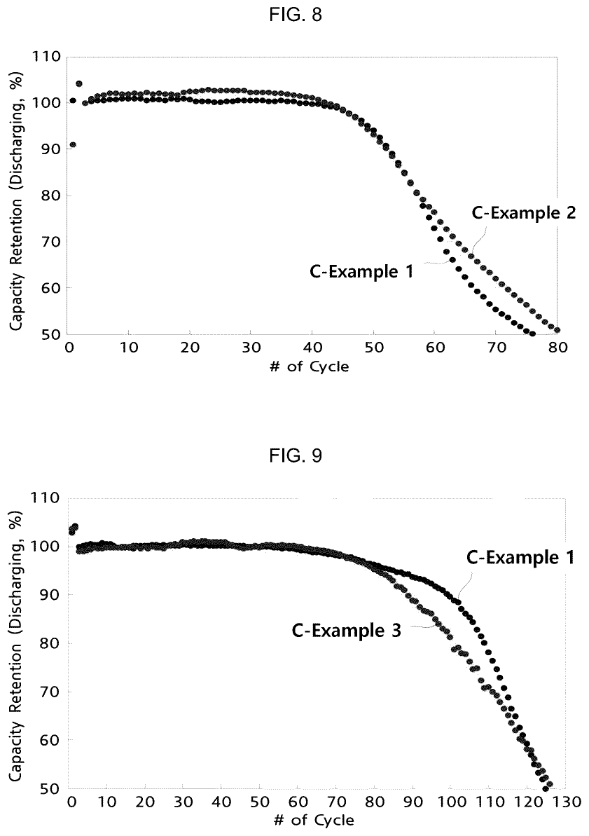

FIG. 8 is a drawing showing the result of repeatedly performing charge/discharge under 1C-rate CC-CV charge and 1C CC discharge conditions on coin cells containing 3.0 g/Ah of electrolyte manufactured using Comparative Example 1 and Comparative Example 2.

Referring to FIG. 8, in the case of Comparative Example 2 where the TTE content in the entire electrolyte is 2.5 mol %, it can be confirmed that the durability improvement effect is insignificant as 57 cycles, when compared to the case where the number of charge/discharge cycles is 57 cycle in Comparative Example 1, at which the capacity retention rate becomes 80%. That is, when TTE is added as an electrolyte additive to the entire electrolyte, it is difficult to achieve an effect of improving the durability of the battery. For reference, TTE has high permittivity, so it is thought that it should be added in excess to enable the delay effect in the FSI dye. However, it was confirmed that it was impossible to implement it because it did not mix with DMSF when added in excess (>5 mol %).

Comparative Example 3 is a case where FEC is added as an electrolyte additive to the main solvent DMSF.

FIG. 9 is a drawing showing the result of repeatedly performing charge/discharge under 1/3C rate CC-CV charge and 1/3C rate CC discharge conditions on coin cells containing 1.5 g/Ah of electrolyte manufactured using Comparative Example 1 and Comparative Example 3.

Referring to FIG. 9, in the case of Comparative Example 3 where the content of FEC in the entire electrolyte is 2.5 mol %, it can be confirmed that the durability improvement effect is insignificant when the number of charge/discharge cycles at which the capacity retention rate becomes 80% is 100 circuits, compared to the case in Comparative Example 1, which is 109 circuits. That is, when FEC is added as an electrolyte additive to the entire electrolyte, it is difficult to achieve an effect of improving the durability of the battery. For reference, FEC has high permittivity, so it is difficult to expect a delay effect of salt reduction decomposition.

### Experimental Example 3 Analysis of Salt Consumption Using Nuclear Magnetic Resonance Analysis (NMR)

The consumed amount of electrolyte components was quantitatively analyzed through NMR analysis of the electrolyte. The increase in resistance in the solution may be due to a decrease in ion conductivity caused by the consumption of the electrolyte itself or partial consumption of the salt. Accordingly, NMR analysis was performed on Li/NMC charge/discharge cycles for the purpose of analyzing the cause of the increase in solution resistance.

For each coin cell manufactured in the above-described manner, in the case of the 0 cycle (after electrode activation and before charge/discharge performance), and after charging to 4.25 V under 1/3C-1/3C conditions at 25° C. and discharging to 2.5 V 1 cycle, and in all the charging and discharging cycles, after performing 10, 30, 50, 100, and 150 cycles with a pause time of 10 minutes after one charge/discharge cycle, the cell was disassembled and immersed in 1 mL DME, and 50 [symbol] of the solution was collected and placed in 500 [symbol] of 6d-DMSO (Dimethyl Sulfoxide) solvent for measurement. The device used here is the Unity Inova 500 MHz-NMR from Varian Technology.

Specifically, FSI/DMSF was quantified by ¹⁷F-NMR and DMSF/DMSO was quantified by ¹H-NMR to calculate FSI/DMSO. Through this, we were able to observe the changes in the absolute amounts of DMSF and FSI within the sample.

For the NMR analysis of the coin cell using Embodiment 1 and Comparative Example 1 as the electrolyte, the coin cell was disassembled after operating the coin cell with 1.5 g/Ah of the electrolyte in the separator for the corresponding number of charge/discharge cycles, and all parts except the case, cap, gasket, and spring were immersed in 1 mL DME, 50 [symbol] of the solution was collected and placed in 500 [symbol] of 6d-DMSO solvent for measurement.

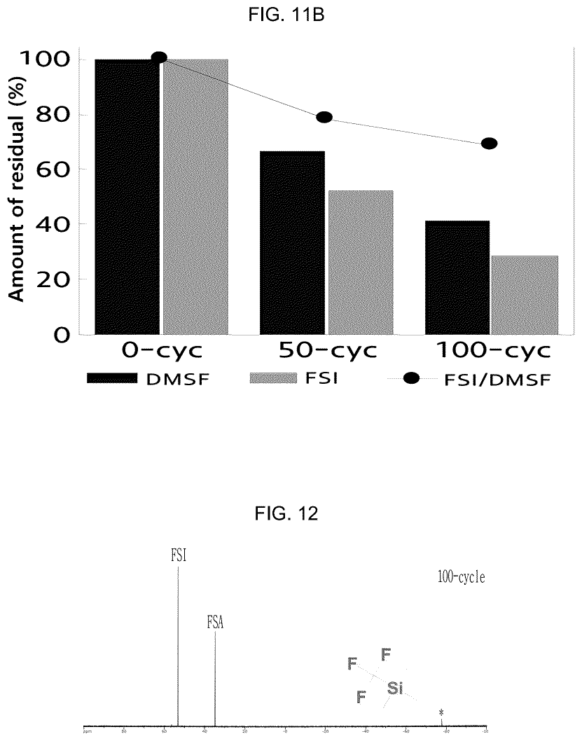

The residual amount of solvent DMSF and lithium salt LiFSI; and FSI (mol)/DMSF (mol); in all parts except the case, cap, gasket, and spring of the coin cell using Comparative Example 1, an electrolyte without electrolyte additive, and Embodiment 1, an electrolyte with TMS-CF3 added as an electrolyte additive, are shown in FIG. 11.

The residual amounts of solvent DMSF and lithium salt, LiFSI in a coin cell using Comparative Example 1, an electrolyte without electrolyte additive, are shown in FIG. 10, and Table 4 shows the residual amounts of solvent DMSF and lithium salt, LiFSI after 100 charge/discharge cycles. The amount of salt and solvent obtained from component analysis of coin cells that had not started charge/discharge was calculated as 100%, and the amount of salt and solvent in the sample collected while the charge/discharge cycle was performed was relatively compared to calculating the residual amount.

TABLE 4

| Perform | | | Residual amount compared to | |
|---|---|---|---|---|
| charge/discharge | Mol for 1 mol DMSO | | initial amount (%) | |
| cycle 100 times | FSI | DMSF | FSI | DMSF |
| Comparative | 0.20 | 0.66 | 36.5 | 60.8 |
| Example 1 | | | | |
| embodiment1 | 0.22 | 0.75 | 41.2 | 68.8 |

As confirmed in FIG. 10 and Table 4, a distinct decomposition of FSI salt was observed following coin cell charge/discharge performance. In addition, the FSI salt decomposition delay effect of embodiment 1 was confirmed in the NMR analysis result.

In particular, after 100 charge/discharge cycles, the residual amount of FSI/DMSF was confirmed to be 61% in Comparative Example 1, while it was 70% in Embodiment 1. That is, the ratio of remaining FSI/DMSF is higher in embodiment 1, which means that the consumption of FSI is delayed in embodiment 1 and more of it remains.

Also, FIG. 12 is a drawing showing the ¹⁷F-NMR result after 100 1/3C cycles in Li/NMC containing embodiment 1 as electrolyte. From the left, sequentially, the signal values of FSI salt, DMSF solvent, and TMS-CF3 additive. The fact that the FSI salt signal remains distinct suggests that the decomposition of the salt is minimal. In addition, the CF3-TMS content observed in FIG. 12 is maintained before and after the battery reaction, suggesting that the decomposition of the additive is minimal.

### Experimental Example 4: Linear Sweep Voltammetry (LSV)

Linear sweep voltammetry of a coin cell using the embodiment and Comparative Example electrolytes was performed.

### (1) Fabrication of Coin Cells for Linear Voltage-Current Analysis

Linear voltage-current analysis was measured using a coin cell type unit cell. Specifically, the coin cell includes a lithium thin film (20 μm on 100 μm Cu, 14 pi) reference electrode and a GF/C (18 pi) separator. Reduction reaction analysis was performed using a copper foil (100 μm, 16 pi) counter, and oxidation reaction analysis was performed using an aluminum foil (100 μm, 16 pi) counter, and measurements were made at a speed of 0.5 mV/s.

The liquid electrolyte was an electrolyte with a LiFSI salt concentration of 1/3, 1/4, and 1/5 FSI (mol)/DMSF (mol), and the electrolytes manufactured in the embodiment and comparative example were used, respectively. Using a micropipette, 100 [symbol] of electrolyte was injected into the separator of the cell of the configuration.

### (2) Linear Voltage-Current Analysis

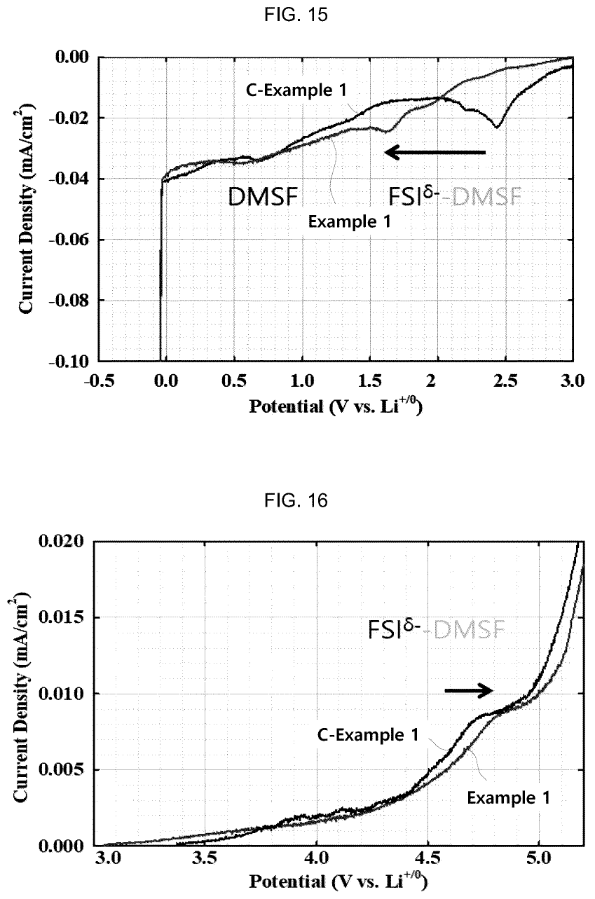

The results of measuring LCV through each coin cell manufactured using the electrolytes manufactured in embodiment 1 and Comparative Example 1 are shown in FIG. 15 and FIG. 16.

Referring to FIG. 15 and FIG. 16, in fact, in the LSV of embodiment 1, the oxidation voltage of the FSI salt shifts slightly positively compared to Comparative Example 1, but the reduction voltage of the FSI salt shifts significantly (by 0.8 V) negatively, and a decomposition delay effect is observed. That is, it can be seen that the additive of embodiment 1 has the effect of delaying the reduction decomposition of the salt.

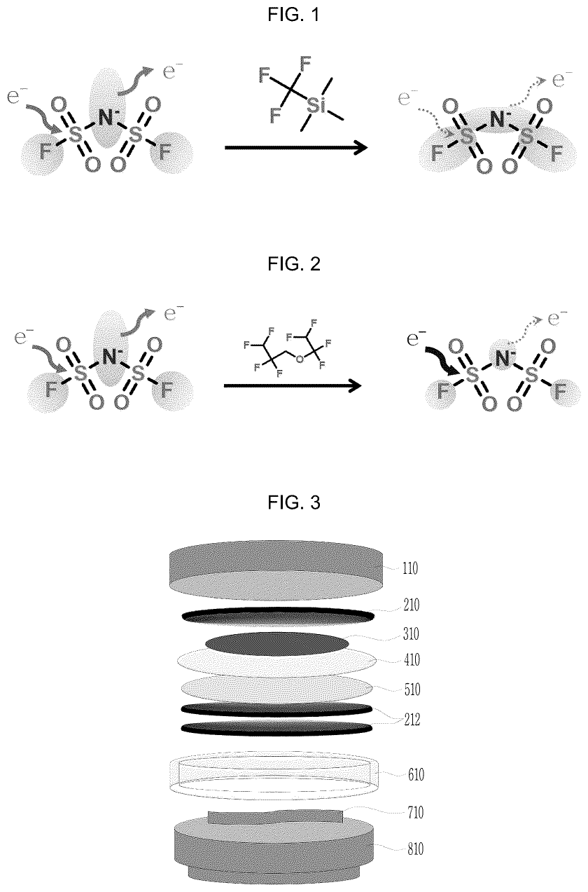

The DMSF solvent in Comparative Example 1 has the ability to weakly dissolve salts, which strengthens the bond between the lithium positive ion and the FSI negative ion, thereby weakening the negative ion characteristics of FSI, delaying the oxidation decomposition of the salt while facilitating the reduction decomposition, which is the decomposition by accepting electrons. The additive of the present disclosure embodiment 1, as published in Table 2, TMS-CF3 has low permittivity and when added, it lowers the permittivity of the solution, thereby inducing delocalization of the FSI negative ion of the electron. As a result, the reduction position of the FSI molecule is filled with electrons, making it difficult for more electrons to enter, which causes the reduction decomposition reaction to be delayed (see FIG. 1). When applying the local overconcentration mechanism, which is a general co-solvent effect such as Comparative Example 2, decomposition may be delayed due to a decrease in electrons at the oxidation position caused by overconcentration, but the reduction reaction is simultaneously promoted due to a decrease in FSI electron density, thereby offsetting the effect (see FIG. 2). As a result, as shown in FIG. 8, the effect of the co-solvent was observed to be minimal.

### Experimental Example 5: Energy Level Analysis

The voltage range was compared by analyzing the energy level for TMS-CF3, TMS-CF2, DMSF, TTE, and FEC.

Energy level calculations can be performed using Materials Studio DMol\hat{ }3 version 2019. First, we used density functional theory (DFT) and employed B3LYP/DNP to GGA-PBE/DNP+ to perform structure optimization of the molecule ground state and then performed single-point energy calculations for the electron ground state based on the optimized structure.

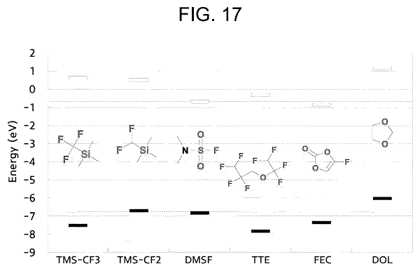

The result is shown in FIG. 17.

Referring to FIG. 17, it was confirmed that TMS-CF3 and TMS-CF2 have a wider voltage range than the main solvent DMSF at the energy level derived from the DFT calculation result.

It was confirmed that by having a wide voltage range, TMS-CF3 and TMS-CF2 are not pre-decomposed during the charge/discharge process, and thus, it can exhibit the effect of delaying the continuous decomposition of FSI salt. That is, it is possible to maintain additives by controlling the salt decomposition environment.

It may be thought that TTE may have the effect of delaying the decomposition of persistent FSI salts since it is not decomposed earlier than DMSF over a wide voltage range. However, as confirmed in the Experimental Examples, this effect was not confirmed. This is thought to be because it has a high permittivity compared to TMS-CF3 and must be added in excess to be expected to have the effect of delaying FSI salt decomposition. However, it was difficult to implement this because it did not mix with DMSF when added in excess (>5 mol %), and it was confirmed that it did not show the durability improvement effect through the substantially salt decomposition delay effect.

FEC has high permittivity, so it is difficult to expect a salt reduction decomposition delay effect, and it can only be used as a negative electrode reduction film-forming additive because it decomposes earlier than DMSF due to its low LUMO (Lowest Unoccupied Molecular Orbital) energy level. Although a delayed effect of FSI salt decomposition can be expected, it is difficult to expect a sustained effect since FEC itself is decomposed. This was confirmed through the insignificant durability improvement effect in the Experimental Example.

Therefore, through comparison with the Comparative Example in the results of the experiments, it can be confirmed that the coin cell containing the electrolyte of the embodiment is excellent electrochemically, such as without degradation in durability even after long-term use.

The present disclosure is not limited to the embodiments, but can be manufactured in various different forms, and a person of ordinary skill in the technical field to which the present disclosure belongs will be able to understand that the present disclosure can be implemented in other specific forms without changing the technical idea or essential features of the present disclosure. Therefore, the embodiments described above should be understood as exemplary in all respects and not restrictive.

### DESCRIPTION OF SYMBOLS

110: Al-coating case
210: Al spacer, 0.5T
310: positive electrode, 14 pi
410: separator, 18 pi
510: negative electrode, 16 pi
212: spacer, 0.5T×2
610: gasket
710: wave spring
810: cap

What is claimed is:

1. An electrolyte additive for a lithium rechargeable battery, the additive expressed by the following: 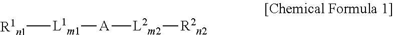
wherein in the Chemical Formula 1,
A is C or Si,
R¹ is a C1 to C10 alkyl group substituted with one or more halogens,
R² is hydrogen, deuterium, halogen, substituted or unsubstituted C1 to C10 alkyl group, substituted or unsubstituted C1 to C10 heteroalkyl group, substituted or unsubstituted C3 to C10 cycloalkyl group, substituted or unsubstituted C2 to C10 heterocycloalkyl group, substituted or unsubstituted C2 to C10 alkenyl group, substituted or unsubstituted C3 to C10 cycloalkenyl group, substituted or unsubstituted C1 to C10 heteroalkenyl group, substituted or unsubstituted C2 to C10 heterocycloalkenyl group, substituted or unsubstituted C2 to C10 alkynyl group, substituted or unsubstituted C3 to C10 cycloalkynyl group, substituted or unsubstituted C1 to C10 heteroalkynyl group, substituted or unsubstituted C2 to C10 heterocycloalkynyl group, substituted or unsubstituted C6 to C10 aryl group, substituted or unsubstituted C2 to C10 heteroaryl group, substituted or unsubstituted C1 to C10 alkoxy group, substituted or unsubstituted C2 to C10 aryloxy group, or any combination thereof,
L¹ and L² are independently, directly bonded, substituted or unsubstituted C1 to C10 alkyl groups,
n1 and n2 are independently integers between 1 and 3,
m1 and m2 are independently integers between 1 and 100.

2. The electrolyte additive of claim 1 wherein the electrolyte additive has a permittivity value of less than 1.0 F/m.

3. The electrolyte additive of claim 1, wherein:
a compound represented by the Chemical Formula 1 has a LUMO (Lowest Unoccupied Molecular Orbital) energy level of −0.6 eV or higher.

4. The electrolyte additive of claim 1, wherein:
a compound represented by the Chemical Formula 1 has a HOMO (Highest Occupied Molecular Orbital) energy level of −6.8 eV or higher.

5. The electrolyte additive of claim 1, wherein:
A is C or Si,
R¹ is a C1 to C6 alkyl group substituted with 1 to 3 halogens,
R² is hydrogen, deuterium, halogen, substituted or unsubstituted C1 to C6 alkyl group, substituted or unsubstituted C1 to C6 heteroalkyl group, substituted or unsubstituted C3 to C6 cycloalkyl group, substituted or unsubstituted C2 to C6 heterocycloalkyl group, substituted or unsubstituted C2 to C6 alkenyl group, substituted or unsubstituted C3 to C6 cycloalkenyl group, substituted or unsubstituted C1 to C6 heteroalkenyl group, substituted or unsubstituted C2 to C6 heterocycloalkenyl group, substituted or unsubstituted C2 to C6 alkynyl group, substituted or unsubstituted C3 to C6 cycloalkynyl group, substituted or unsubstituted C1 to C6 heteroalkynyl group, substituted or unsubstituted C2 to C6 heterocycloalkynyl group, substituted or unsubstituted C6 to C10 aryl group, substituted or unsubstituted C2 to C6 heteroaryl group, substituted or unsubstituted C1 to C6 alkoxy group, substituted or unsubstituted C2 to C6 aryloxy group, or any combination thereof,
n1 and n2 are independently integers from 1 to 3.

6. The electrolyte additive of claim 1, wherein:
A is C or Si,
R¹ is a C1 to C3 alkyl group substituted with 1 to 3 halogens,
R² is hydrogen, deuterium, halogen, a substituted or unsubstituted C1 to C3 alkyl group, a substituted or unsubstituted C1 to C3 heteroalkyl group, a substituted or unsubstituted C3 to C6 cycloalkyl group, a substituted or unsubstituted C2 to C6 heterocycloalkyl group, a substituted or unsubstituted C2 to C3 alkenyl group, a substituted or unsubstituted C3 to C6 cycloalkenyl group, a substituted or unsubstituted C1 to C3 heteroalkenyl group, a substituted or unsubstituted C2 to C6 heterocycloalkenyl group, a substituted or unsubstituted C2 to C3 alkynyl group, a substituted or unsubstituted C3 to C6 cycloalkynyl group, a substituted or unsubstituted C1 to C3 heteroalkynyl group, a substituted or unsubstituted C2 to C6 heterocycloalkynyl group, a substituted or unsubstituted C6 to C10 aryl group, a substituted or unsubstituted C2 to C6 a heteroaryl group, a substituted or unsubstituted C1 to C3 alkoxy group, a substituted or unsubstituted C2 to C6 aryloxy group, or any combination thereof,
n1 and n2 are independently integers from 1 to 3.

7. The electrolyte additive of claim 1, wherein:
A is C or Si,
R¹ is a C1 to C3 alkyl group substituted with 2 to 3 halogens,
R² is hydrogen, deuterium, halogen, a substituted or unsubstituted C1 to C3 alkyl group, a substituted or unsubstituted C1 to C3 heteroalkyl group, a substituted or unsubstituted C3 to C6 cycloalkyl group, a substituted or unsubstituted C2 to C6 heterocycloalkyl group, a substituted or unsubstituted C2 to C3 alkenyl group, a substituted or unsubstituted C3 to C6 cycloalkenyl group, a substituted or unsubstituted C1 to C3 heteroalkenyl group, a substituted or unsubstituted C2 to C6 heterocycloalkenyl group, a substituted or unsubstituted C2 to C3 alkynyl group, a substituted or unsubstituted C3 to C6 cycloalkynyl group, a substituted or unsubstituted C1 to C3 heteroalkynyl group, a substituted or unsubstituted C2 to C6 heterocycloalkynyl group, a substituted or unsubstituted C6 to C10 aryl group, a substituted or unsubstituted C2 to C6 a heteroaryl group, a substituted or unsubstituted C1 to C3 alkoxy group, a substituted or unsubstituted C2 to C6 aryloxy group, or any combination thereof,
L¹ and L² are independently, directly bonded or unsubstituted C1 to C10 alkyl groups,
n1 and n2 are independently integers from 1 to 3.

8. The electrolyte additive of claim 1, wherein:
A is C or Si,
R¹ is —CF₃ or —CF₂,
R² is hydrogen, deuterium, halogen, unsubstituted C1 to C3 alkyl group, unsubstituted C1 to C3 heteroalkyl group, unsubstituted C3 to C6 cycloalkyl group, unsubstituted C2 to C6 heterocycloalkyl group, unsubstituted C2 to C3 alkenyl group, unsubstituted C3 to C6 cycloalkenyl group, unsubstituted C1 to C3 heteroalkenyl group, unsubstituted C2 to C6 heterocycloalkenyl group, unsubstituted C2 to C3 alkynyl group, unsubstituted C3 to C6 cycloalkynyl group, unsubstituted C1 to C3 heteroalkynyl group, unsubstituted C2 to C6 heterocycloalkynyl group, unsubstituted C6 to C10 aryl group, unsubstituted C2 to C6 heteroaryl group, unsubstituted C1 to C3 alkoxy group, substituted or unsubstituted C2 to C6 aryloxy group, or any combination thereof,
L¹ and L² are independently, directly bonded or unsubstituted C1 to C6 alkyl groups,
n1 and n2 are independently integers from 1 to 3.

9. The electrolyte additive of claim 1, wherein:
A is C or Si,
R¹ is —CF₃ or —CF₂,
R² is hydrogen, halogen, unsubstituted C1 to C3 alkyl group, unsubstituted C2 to C3 alkenyl group, unsubstituted C2 to C3 alkynyl group, or any combination thereof,
L¹ and L² are independently, directly bonded or unsubstituted C1 to C3 alkyl groups,
n1 is an integer of 1 or 2,
n2 is an integer from 1 to 3.

10. An electrolyte additive for a lithium rechargeable battery that is

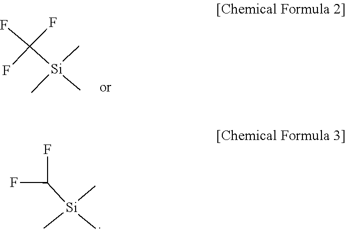

11. An electrolyte for lithium rechargeable battery, comprising:
a) the electrolyte additive of claim 1; and
b) a solvent component comprises i) linear or cyclic ether solvent and/or ii) sulfamoyl solvent as a main solvent.

12. The electrolyte of claim 11, wherein:
the solvent component comprises a sulfamoyl solvent containing fluorine as a substituent.

13. The electrolyte of claim 11, wherein:
the solvent component contains a fluorosulfonyl group represented by:

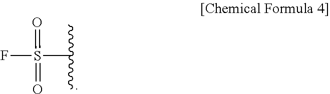 [SMILES: *S(=O)(=O)F]

14. The electrolyte of claim 11, wherein:
the solvent component comprises a solvent represented by: 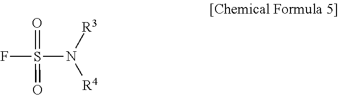
the R³ and R⁴ are each independently a functional group selected from the group consisting of hydrogen and an unsubstituted C1-10 alkyl group.

15. The electrolyte of claim 11, wherein:
the electrolyte additive comprises an alkyl group of C1 to C10 substituted with two to three halogens,
a mole ratio of the main solvent component to the electrolyte additive is about 0.99:0.01 to 0.95:0.05.

16. A lithium rechargeable battery, comprising:
a positive electrode;
negative electrode; and
a separator interposed between the positive electrode and the negative electrode; and
the electrolyte of claim 10.

17. A lithium rechargeable battery of claim 16 further comprising:
(i) LIFSI as a lithium salt; and
(ii) a solvent component comprising a fluorine-substituted sulfonyl solvent, wherein a mole ratio of the fluorine-substituted sulfonyl solvent to the electrolyte additive is about 0.99:0.01 to 0.95:0.05.

18. The lithium rechargeable battery of claim 17, wherein the electrolyte additive is represented by

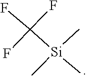

19. The lithium rechargeable battery of claim 17, wherein the electrolyte additive is represented by

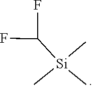

20. The lithium rechargeable battery of claim 17, wherein the solvent component contains a fluorosulfonyl group represented by 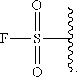 [SMILES: *S(=O)(=O)F]
